(19) United States
(12) Patent Application Publication
(10) Pub. No.: US 2022/0212343 A1
(43) Pub. Date: Jul. 7, 2022

(54) OPERATION COMMAND GENERATION DEVICE, MECHANISM CONTROL SYSTEM, NON-TRANSITORY COMPUTER READABLE STORAGE MEDIUM, OPERATION COMMAND GENERATION METHOD, AND MECHANISM CONTROL METHOD

(71) Applicant: KABUSHIKI KAISHA YASKAWA DENKI, Kitakyushu-shi (JP)

(72) Inventors: Tomohiro KAMISHIO, Kitakyushu-shi (JP); Yasufumi YOSHIURA, Kitakyushu-shi (JP)

(73) Assignee: KABUSHIKI KAISHA YASKAWA DENKI, Kitakyushu-shi (JP)

(21) Appl. No.: 17/561,543

(22) Filed: Dec. 23, 2021

(30) Foreign Application Priority Data
Jan. 7, 2021 (JP) 2021-001712

(51) Int. Cl. B25J 9/16

(52) U.S. Cl. CPC B25J 9/1664; B25J 9/1651; B25J 9/1638; B25J 9/1661

(57) ABSTRACT

An operation command generation device includes movement curve designation circuitry configured to determine a movement curve describing an operation of each of at least one mechanism element included in a virtual mechanism, and operation command generation circuitry configured to generate an operation command to control an actual mechanism based on the movement curve.

### CROSS-REFERENCE TO RELATED APPLICATIONS

The present application claims priority under 35 U.S.C. § 119 to Japanese Patent Application No. 2021-001712, filed Jan. 7, 2021. The contents of this application are incorporated herein by reference in their entirety.

### BACKGROUND OF THE INVENTION

### Technical Field

The present invention relates to an operation command generation device, a mechanism control system, a non-transitory computer readable storage medium, an operation command generation method, and a mechanism control method.

### Background Art

Japanese Patent Application Laid-Open No. H05-90386 shows a motor control device in a conveyance device that calculates a command value that satisfies a stroke and a movement time given from an interpreter with reference to one selected cam curve table from a cam curve memory provided with a plurality of types of cam curve tables.

### SUMMARY OF THE INVENTION

According to one aspect of the present invention, an operation command generation device includes movement curve designation circuitry configured to determine a movement curve describing an operation of each of at least one mechanism element included in a virtual mechanism, and operation command generation circuitry configured to generate an operation command to control an actual mechanism based on the movement curve.

According to another aspect of the present invention, a mechanism control system includes an operation command generation device and mechanism control circuitry. The operation command generation device includes movement curve designation circuitry configured to determine a movement curve describing an operation of each of at least one mechanism element included in a virtual mechanism, and operation command generation circuitry configured to generate an operation command to control an actual mechanism based on the movement curve. The mechanism control circuitry is configured to control the actual mechanism according to the operation command.

According to further aspect of the present invention, a non-transitory computer readable storage medium is configured to retrievably store a computer-executable program therein. The computer-executable program causing a computer to perform an operation command generation method. The method includes determining a movement curve describing an operation of each of at least one mechanism element included in a virtual mechanism, and generating an operation command to control an actual mechanism based on the movement curve.

According to the other aspect of the present invention, an operation command generation method includes determining a movement curve describing an operation of each of at least one mechanism element included in a virtual mechanism, and generating an operation command to control an actual mechanism based on the movement curve.

According to yet further aspect of the present invention, a mechanism control method includes determining a movement curve describing an operation of each of at least one mechanism element included in a virtual mechanism, generating an operation command to control an actual mechanism based on the movement curve, and outputting the operation command to the actual mechanism.

### DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a conceptual diagram illustrating a mechanism control system according to a preferred embodiment of the present invention and an actual mechanism controlled by the mechanism control system.

FIG. 2 is a diagram showing a configuration of a general computer as an example of a hardware configuration of the operation command generation device.

FIG. 3 is a conceptual diagram showing the relationship between the actual mechanism and the virtual mechanism handled by the operation command generation device.

FIG. 4 is a structural block diagram of the operation command generation device.

FIG. 5 is a diagram showing an example of a GUI presented to the user through the monitor by the movement curve designation part.

FIG. 6 is a conceptual diagram illustrating a method of generating an operation command by the operation command generation part.

FIGS. 7A and 7B are diagrams for explaining an offset operation.

FIG. 8 is a diagram showing an example of a GUI presented to the user by the motor selection information output unit.

FIG. 9 is a diagram showing an example of a GUI for a user to select a model of an electric motor product, which is displayed by selecting a model designation section on the GUI of FIG. 8.

FIG. 10 is a diagram showing an example of a GUI through which a user selects a physical model.

FIG. 11 is an overall structural block diagram of the mechanism control system including the operation command generation device.

FIG. 12 is a diagram showing an example of a GUI on the operation terminal.

FIG. 13 is a flowchart showing a method of generating an operation command for the actual mechanism and a method of controlling the actual mechanism, which are executed by the mechanism control system.

### DESCRIPTION OF EMBODIMENTS

General-purpose industrial robots are widely used because they have a high degree of freedom of operation and can be widely applied to various automatic machines. On the other hand, the high degree of freedom of movement means that the programming of the industrial robot for specific applications requires technical knowledge specific to the industrial robot.

Incidentally, not all automatic machines widely used in the world are necessarily realized by general-purpose industrial robots, and there are many automatic machines realized by using a unique mechanical mechanism, for example, a cam mechanism or a link mechanism. It is considered that the introduction of an industrial robot to update such an aging automatic machine or the like brings about many advantages such as facilitation of maintenance due to commonality of equipment and coping with small-lot production of various products due to flexible change of an operation pattern.

However, since the operation realized by the unique mechanical mechanism is described based on the unique mechanical mechanism, the operation cannot be immediately transferred to the industrial robot, and since a technician who has expert knowledge of the industrial robot is required, the assets of automatic control which have been realized by the unique mechanical mechanism cannot be effectively utilized.

It is considered that this situation occurs not only in a general-purpose industrial robot but also in an attempt to realize an automatic control asset which is described based on a specific mechanism in another mechanism.

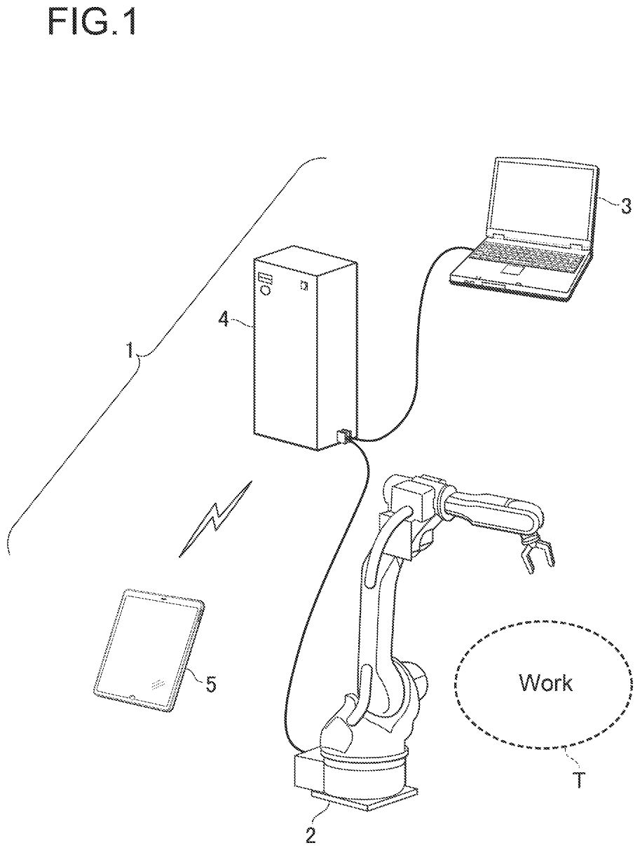

FIG. 1 is a conceptual diagram illustrating a mechanism control system 1 according to a preferred embodiment of the present invention and an actual mechanism 2 controlled by the mechanism control system 1. In this example, the mechanism control system 1 includes an operation command generation device 3, a mechanism control device 4, and an operation terminal.

The actual mechanism 2 is a mechanical mechanism that automatically executes some work T. As shown in FIG. 1, the actual mechanism in the present embodiment is obtained by attaching an appropriate end effector to a general-purpose industrial robot, but the mechanical mechanism of the actual mechanism 2 is not necessarily limited. When an industrial robot is used, other types of robots, such as a horizontal articulated type (scalar type), a parallel link type, and an orthogonal type, may be used in addition to the vertical articulated robot as illustrated. Further, a general-purpose or dedicated mechanism other than the robot may be used. As the dedicated mechanism, a link mechanism, a cam mechanism, or a combination thereof is assumed.

In this example, the actual mechanism 2 includes an electric motor as its power source, and its operation is mainly performed by control of the electric motor. That is, the operation of the industrial robot constituting the actual mechanism 2 is realized by the servo motor installed in each joint. However, the actual mechanism 2 may include a power source other than the electric motor. For example, a pneumatic or hydraulic device or the like may be appropriately used for the operation of the end effector, or a part or all of a device other than an electric motor may be used as a power source of a mechanism other than the end effector of the actual mechanism 2.

Further, the term “actual mechanism” is used in contrast to the term “virtual mechanism” which will be used later in this specification. Here, the “actual mechanism” means a mechanical mechanism that is actually constructed and used to execute the task T. On the other hand, the “virtual mechanism 7” means a mechanical mechanism which is virtually conceived as a mechanism for executing the work T and is not actually constructed and used.

The work T may be any work as long as it is automatically executed by the actual mechanism 2. The contents of other operations T such as processing, transportation, inspection, and demonstration of an article are not limited.

The mechanism control system 1 is a single device or a system including a plurality of devices having a function of controlling the operation of the actual mechanism 2. In the example shown in FIG. 1, the mechanism control system includes a mechanism control device 4 for supplying power to and controlling the actual mechanism 2, an operation command generation device 3 for generating an operation command for the actual mechanism 2 and transferring the operation command to the mechanism control device 4 to control the actual mechanism 2, and an operation terminal 5 for manually operating or stopping the actual mechanism 2 in an operational state or non-operational state and instructing change of the operating speed and direction thereof. It is shown that each device is independent and connected via electrical information communication respectively.

Here, since the actual mechanism 2 is an industrial robot, the mechanism control device 4 is a so-called robot controller. In addition to a servo controller that controls a servo motor included in the actual mechanism 2, the mechanism control device 4 is provided with a control mechanism that electronically controls a pneumatic device and other various auxiliary devices in accordance with an operation command generated by the operation command generation device 3.

In this example, a general computer is used as hardware of the operation command generation device 3, and the computer is caused to function as the operation command generation device 3 by software executed on the hardware. The operation command generation device 3 generates an operation command which is a command group to be executed when the mechanism control device 4 controls the actual mechanism 2. The user inputs the work T to be realized by the actual mechanism 2 to the operation command generation device 3 based on the virtual mechanism 7 as described later, and the operation command generation device 3 generates an operation command so that the work T thus input is realized by the actual mechanism 2. The user's input and the generation of an operation command in the operation command generation device 3 will be described later in detail.

The operation terminal 5 is a device for an operator to instruct conditions at the time of execution, such as start and stop of execution of the work T, an execution speed, a direction, and the like, to the mechanism control device 4 in which an operation command is prepared and preparation for automatically executing the work T by the actual mechanism 2 is completed. The operation terminal 5 is not a device which is always necessary for the mechanism control system, and may be provided as necessary. The instruction to start and stop the automatic execution of the work T by the mechanism control device 4 and the timing thereof are not necessarily based on the instruction of the operator using the operation terminal 5, and may be based on a signal from an upstream or downstream device (not illustrated) with respect to the mechanism control device 4.

The hardware configuration of the mechanism control system 1 itself is not limited to the combination of the operation command generation device 3, the mechanism control device 4, and the operation terminal 5 illustrated in FIG. 1, and one device may have a plurality of functions of these devices, or vice versa. For example, the mechanism control device 4 may have a function as the operation command generation device 3, or vice versa. In addition, in FIG. 1, the operation command generation device 3 and the mechanism control device 4 are illustrated to be capable of performing information communication with each other by wired connection, and the mechanism control device 4 and the operation terminal 5 are illustrated to be capable of performing information communication with each other by wireless connection, but a mode of the connection is not limited. The devices may be communicatively coupled via any telecommunications network, including the Internet. In addition, a part of the functions of the mechanism control system 1, for example, the function as the operation command generation device 3 may be provided by so-called cloud computing via a telecommunication network.

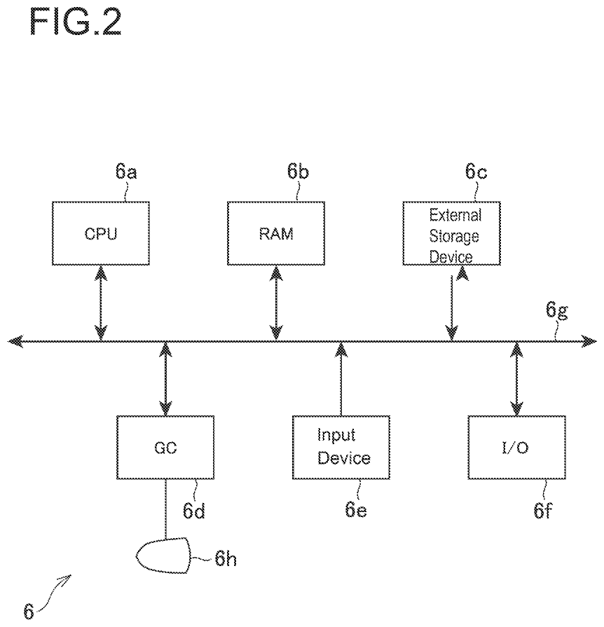

Hereinafter, the operation command generation device 3 included in the mechanism control system 1 will be described in detail. FIG. 2 is a diagram showing a configuration of a general computer 6 shown as an example of a hardware configuration of the operation command generation device 3. In the computer 6, a CPU (Central Processing Unit) 6a serving as a processor, a RAM (Random Access Memory) 6b serving as a memory, an external storage device 6c, a GC (Graphics Controller) 6d, input devices 6e, and I/Os (Input/Output) 6f are connected to each other via a databus 6g so as to be able to exchange electrical signals with each other. Note that the hardware configuration of the computer 6 shown here is an example, and a configuration other than this may be adopted.

The external storage device 6c may be a device capable of statically recording information, such as a hard disk drive (HDD) or a solid state drive (SSD). Signals from the GC 6d are output to a monitor 6h, such as a CRT (Cathode Ray Tube) or a so-called flat panel display, on which a user visually recognizes an image, and displayed as an image. The input devices 6e are one or more devices for a user to input information, such as a keyboard, a mouse, and a touch panel, and the I/O 6f are one or more interfaces for the computer 6 to exchange information with external devices. The I/O 6f may include various ports for wired connection and a controller for wireless connection.

A computer program for causing the computer 6 to function as the operation command generation device 3 is stored in the external storage device 6c, read by the RAM 6b as necessary, and executed by the CPU 6a. That is, a program code for causing the computer 6 to function as the operation command generation device 3 by being executed by the RAM 6b is stored in the CPU 6a. Such a computer program may be provided by being recorded on an appropriate computer-readable information recording medium such as an appropriate optical disk, a magneto-optical disk, or a flash memory, or may be provided via an external information communication line such as the Internet via I/O 6f.

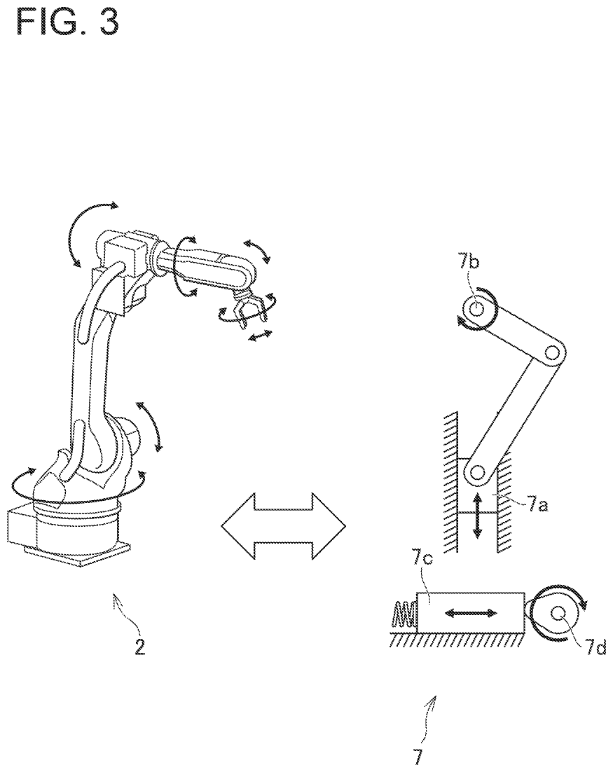

FIG. 3 is a conceptual diagram showing the relationship between the actual mechanism 2 and the virtual mechanism 7 handled by the operation command generation device 3. Here, the virtual mechanism 7 is illustrated as a combination of a slider crank mechanism and a flat cam mechanism, but this is shown as a conceptual example, and differs depending on the work T desired by the user.

At this time, an operation necessary for the work T is determined for each mechanism element constituting the virtual mechanism 7. For example, the links are designed so that the displacements of the sliders 7a are determined with the rotation of the crankshaft 7b, and the cam curves are designed so that the displacements of the tables 7c are determined with the rotation of the camshaft 7d. Power shafts such as a crankshaft 7b and a camshaft 7d of the virtual mechanism 7 operate in conjunction with rotation of virtual master shafts (sometimes referred to as “master cams” or the like in mechanism design).

Such a virtual mechanism 7 is conceived as a unique mechanical mechanism that realizes the task T. Therefore, the operation of each mechanism element of the virtual mechanism 7 has high affinity with each operation necessary for realizing the task T. That is, it is assumed that there is a good intuitive correspondence with each action of the task T. Alternatively, the virtual mechanism 7 may represent a mechanical mechanism itself of an automatic machine actually used in the past, and the operation of each mechanical element of the virtual mechanism 7 may be the operation of the mechanical mechanism of the automatic machine.

On the other hand, the actual work T is realized by the actual mechanism 2. The actual mechanism 2 is usually different from the virtual mechanism 7 in mechanical mechanism, and in this example, the actual mechanism 2 is a general-purpose vertical articulated robot as shown in the figure. The actual mechanism 2 has multiple degrees of freedom (seven degrees of freedom in the illustrated example), and can reproduce the work T executed by the virtual mechanism 7 even though the mechanical mechanisms are different from each other.

At this time, the operation command to be given to the actual mechanism 2 in order to realize the work T must be in accordance with the mechanical configuration of the actual mechanism 2. That is, in the example of FIG. 3, the task T must be described as an operation in the coordinate system of the actual mechanism 2 which is a vertical articulated robot. However, since the actual mechanism 2 is not a mechanical mechanism designed based on the work T, it is difficult to describe the operation included in the work T as the operation of the actual mechanism 2. On the other hand, since the virtual mechanism 7 is a machine mechanism designed in accordance with the work T, it is easy to describe the work T as a set of operations of respective mechanism elements included in the virtual mechanism 7, or the virtual mechanism 7 can be immediately obtained as an operation of a machine mechanism of an automatic machine actually used in the past.

The operation command generation device 3 is a device that generates an operation command for the actual mechanism 2 based on the work T described intuitively or expressed as an operation of each mechanism element included in the virtual mechanism 7 that already exists. Therefore, the operation command generation device 3 receives a description of an operation based on the virtual mechanism 7 as an input and outputs an operation command for the actual mechanism 2.

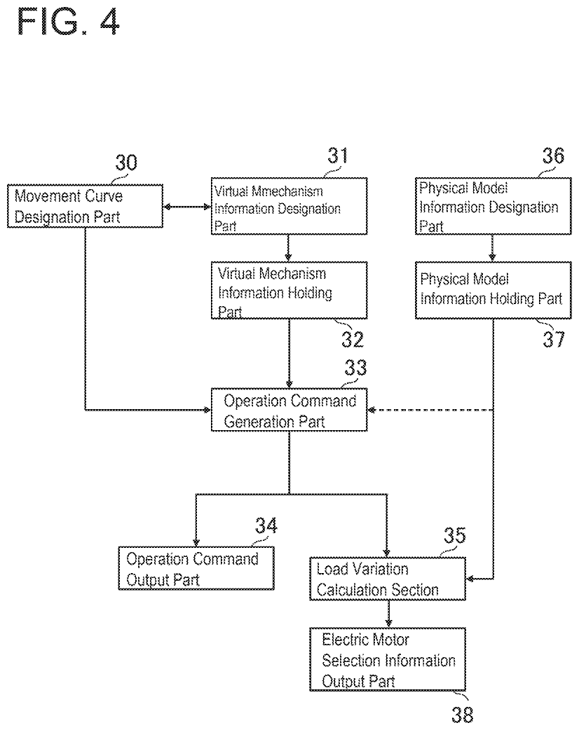

FIG. 4 is a structural block diagram of the operation command generation device 3. In a case where the operation command generation device 3 is realized by the general computer 6 illustrated in FIG. 2, each function illustrated in the drawing is realized by executing a computer program by the CPU 6a, allocating a storage area to the RAM 6b or the external storage device 6c, or the like. First, each structural block shown in FIG. 4 will be briefly described, and then each function will be described in detail.

The movement curve designation part (movement curve designation circuitry) 30 is provided for the user to designate a movement curve describing the operation of one or more mechanism elements included in the virtual mechanism 7. The movement curve designation part 30 includes a GUI (Graphical User Interface) for the user to designate a movement curve, and is configured to obtain a movement curve by the user inputting a unit movement curve obtained by designating a start point, an end point, and a curve shape, as will be described later.

The virtual mechanism information designation part 31 is provided to designate virtual mechanism information, and the designated virtual mechanism information is held in the virtual mechanism information holding part 32. The virtual mechanism information includes at least a mechanical relationship between a plurality of mechanism elements. Qualitatively, the virtual mechanism information is a part or all of information necessary for converting the operation of the mechanism represented in the virtual mechanism 7 into the operation of the mechanism in the actual mechanism 2. In the present embodiment, the virtual mechanism information includes variables for generating degrees of freedom in the virtual mechanism 7, a relationship between the variables, and a relationship with coordinates in the actual mechanism 2. A specific example of the virtual mechanism information will be described later.

The variables included in the virtual mechanism information may be designated by the virtual mechanism information designation unit 31 or may be designated by the movement curve designation part 30. For example, if the user adds an “axis” on the GUI of the movement curve designation part 30, since the “axis” is a variable with one degree of freedom to be included in the virtual mechanism information, the information of the “axis” may be sent to the virtual mechanism information designation part 31 and the corresponding variable may be added to the virtual mechanism information. Conversely, if a variable specifying the operation of a mechanism element included in the virtual mechanism 7 is added to the GUI of the virtual mechanism information designation part 31, the variable is handled as an “axis” in the movement curve designation part 30, and the information of the variable is to be sent to the movement curve designation part 30 and the information of the corresponding “axis” may be added to the movement curve designation part 30.

The operation command generation part (operation command generation circuitry) 33 generates an operation command of the actual mechanism 2 based on the movement curve designated by the user in the movement curve designation part 30. At this time, the operation command generation part 33 uses the virtual mechanism information held in the virtual mechanism information holding part 32. Since the actual mechanism 2, which is an industrial robot, can be operated by an operation command specifying target coordinates and an attitude in its coordinate space, i. e., a so-called robot coordinate system, the operation command generation part 33 can generate an operation command from the coordinates and the attitude to be taken by the actual mechanism 2 obtained using the movement curve and the virtual mechanism information.

When the actual mechanism 2 is not an industrial robot but another arbitrary mechanism, an operation command to be given to the actual mechanism 2 may not be immediately obtained only from the target coordinates and orientation. In such a case, the operation command generation part 33 generates an operation command by obtaining physical model information of the actual mechanism 2 described later from the physical model information holding part (a physical model information storage) 37.

The generated operation command is output from the operation command output part 34 to the mechanism control device 4. The mechanism control device 4 stores the operation command received from the operation command output part 34, controls the actual mechanism 2 based on the operation command, and causes the actual mechanism 2 to perform the work T.

Further, the load variation calculation section (load variation calculation circuitry) 35 calculates a load variation of the electric motor included in the actual mechanism 2, which is caused by the work T input by the user. Since this load variation depends on the specific configuration, shape, and weight of the actual mechanism 2, the load variation calculation section 35 calculates the load variation of the electric motor based on the physical model information held in the physical model information holding part 37 in addition to the contents of the work T. The physical model information is designated by the user by the physical model information designation part 36. The physical model information designation part 36 includes an appropriate GUI for the user to designate the physical model information.

The motor selection information output unit 38 outputs motor selection information indicating whether or not to select a motor based on the load variation calculated by the load variation calculation section 35. This output is presented to the user through the monitor 6h of the computer 2, for example, and provides information about the electric motor to be selected when the user constructs the actual mechanism 2 that realizes the work T.

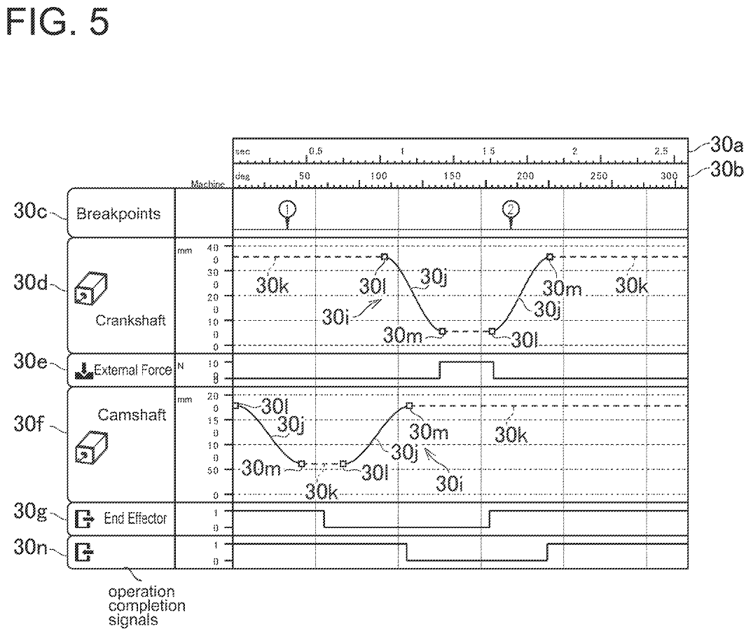

FIG. 5 is a diagram showing an example of a GUI presented to the user through the monitor 6h by the movement curve designation part 30. In the GUI shown in this example, a movement curve or the like can be input in a graph format in which the horizontal axis represents time and the rotation angle of the master shaft, and the vertical axis represents displacement of a mechanism element or changes in other specified items. Each element shown in the GUI will be described below.

The horizontal axis scale indicating the horizontal axis is indicated by both the time scale 30a and the master shaft rotation-angle scale 30b in the upper part of the GUI. The master shaft rotation angle scale 30b indicates a rotation angle of a virtual master shaft that repeatedly rotates, and the range thereof is 0° to 360°. The time scale 30a indicates the elapsed time corresponding to the master shaft rotation angle 30b. The correspondence relationship between the master shaft rotation angle scale 30b and the time scale 30a, that is, the time required for one rotation of the master shaft can be arbitrarily set. Further, in FIG. 5, the unit of the time scale 30a is represented by seconds (sec), and the unit of the master shaft rotation angle scale 30b is represented by degrees (deg), but these units may be arbitrarily changed. For example, the unit of the time scale 30a may be minutes, times, or days, and the unit of the master shaft rotation angle scale 30b may be radians (rad).

On the vertical axis, the GUI is designed so that the user can appropriately add designation items necessary for describing the task T. In the example of FIG. 5, breakpoints 30c, shafts 30d (crankshafts), external forces 30e, shafts 30f (camshafts), output signals 30g (end effectors), and input signals 30h (operation completion signals) are shown from the top. Since a name that is easily understood by the user can be assigned to the designated item as appropriate, the name shown in FIG. 5 may be different from the name described here. The names shown in FIG. 5 are indicated in parentheses in the above text.

First, the shafts 30d and 30f, which are “shafts”, will be described. The “shaft” mentioned here is a variable constituting the degree of freedom of the virtual mechanism 7, and indicates displacement of a mechanism element of the virtual mechanism 7. The unit of 30d and 30f shown in FIG. 5 are assumed to be the slider crank mechanism of FIG. 3 and the flat cam mechanism of FIG. 3, respectively, the displacements of the slider 7a and the stage 7c driven by the flat cam are shown, but when the mechanism element is a rotary body such as a turntable, the rotation angle may be used as the displacements. Of course, the unit of the displacements is arbitrary, and is not limited to millimeters (mm) shown for the shaft 30d and the shaft 30f in FIG. 5, and may be set arbitrarily.

In the designation item of “shaft”, the horizontal axis represents time or a master shaft rotation angle, and the vertical axis represents displacements, so that the user can designate a movement curve 30i indicating changes in displacements of the mechanism elements in the time direction using the GUI. Here, the movement curve 30i includes two kinds of movement curves, i.e., a unit movement curve 30j shown in the experiment and a connection movement curve 30j connecting the unit movement curves 30k.

What is important when specifying the movement curve 30i in the movement curve designation part 30 is the displacements that must occur in the mechanism elements in order to realize the task T. Therefore, the movement curve designation part 30 is designed such that the user can construct the movement curve 30i without designating the shape of the movement curve 30i over the entire range of the movement curve 30i (that is, the range of the master shaft rotation angle from 0° to 360°).

That is, when the user specifies the unit movement curve 30j included in the movement curve 30i, the movement curve 30i is obtained. The unit movement curve 30j is a curve describing a change of the displacements of the mechanism elements from a certain initial value to a target value. The movement curve designation part 30 obtains the unit movement curve 30j by causing the user to designate the start point 30l and the end point 30m and the curve shape of the unit movement curve 30j connecting the start point 30l and the end point 30m. The start point 30l and the end point 30m specify time (or master shaft rotation angle) and displacements, respectively. The curve shape may be selected from various curve shapes prepared in advance by the movement curve designation part 30, or may be freely designed by the user.

As the curve shape, a representative curve, for example, a trapezoidal acceleration curve or a curved acceleration curve (a so-called S-shaped acceleration curve) may be selectively prepared in advance, and a curve of displacement in a crank mechanism or a link mechanism may be arbitrarily selected. In addition to this, a GUI may be separately prepared to design an arbitrary cam curve, or an acceleration curve or a jerk curve may be designated so that the user can design an arbitrary curve. Further, it may be possible to import a curve designed by another software, for example, a dedicated software for designing a cam curve.

When the user designates a necessary unit movement curve 30j, a movement curve designation part 30 connects adjacent unit movement curves 30j so as to be continuous by a connection movement curve 30k. To be more specific, the connection movement curve 30k is a curve connecting the end point 30m of the previous unit movement curve 30j and the start point 30l of the next unit movement curve 30j, and its curve shape follows a predetermined shape, for example, a curve acceleration curve. The curve shape of the connection movement curve 30k may be arbitrarily set by the user.

Here, since the movement curve 30i is a repetition curve repeated in a predetermined cycle, that is, in a cycle in which the master shaft makes one rotation, the displacements at the start point and the end point must coincide with each other. Therefore, the movement curve designation part 30 connects the end point of the rearmost unit movement curve 30j designated by the user and the start point of the foremost unit movement curve 30j by the connection movement curve 30k so as to be continuous by repetition.

Further, an external force 30f, which is a designation item indicating the external force, may be provided for arbitrary “shaft”. The external force 30f is designation item that designate the external force acting on the associated “shaft”, here the shaft 30d located directly above. Specifically, if the “shaft” is a mechanism element, for example, a crank press, a press reaction force acts on the mechanism element, and if the mechanism element is an object that lifts and moves an article, gravity due to holding of the article acts on the mechanism element. Such external force 30 generated in accordance with the progress of the work T can be described in the external force 30f.

Since the external force 30f is used to calculate the load fluctuation of the electric motor as will be described later, the designation of the external force is not essential when the load fluctuation is not calculated. Further, in the present embodiment, the direction of force designated by the external force 30f is the direction of “shaft” associated with the external force 30f. Therefore, if a force is specified in a certain time range, it means that a specified force acts on the “shaft” in the axial direction. Note that, in the present embodiment, the signs of the shaft 30d and the external force 30e coincide with each other, but the signs may be arbitrary.

The output signal 30g designate changes in signal output from the mechanism control device 4 to the outside with the progress of time, i. e., rotation of the master shaft. This signal indicates, for example, a high/low change in impedance of an external output contact of the mechanism control device 4, and an external device connected to the contact performs an operation based on the signal output from the mechanism control device 4. In this example, the virtual mechanism 7 of FIG. 3 is instructed to switch the operation of the end effector (not illustrated), and a signal is output at the timing shown in FIG. 5. The output signals 30g are not limited to high/low binary signals as described herein, and may be continuous signals, for example, voltage signals that output digital values based on a specific protocol.

The input signals 30h are signals input to the mechanism control device 4 from an external device, for example, an upstream or downstream device that is to execute the work T in conjunction with the actual mechanism 2, a sensor for detecting the state of the work T, or the like. The input signals 30h shown in FIG. 5 are also described as indicating a high/low change in impedance of an external input contact included in the mechanism control device 4.

Here, the values of the input signals 30h are also described with respect to time or the rotation angle of the master shaft, as are the output signals 30g and other specified items. However, since the input signals 30h indicate values input from an external device that is not under the control of the mechanism control device 4, the timing at which the values change cannot be controlled by the mechanism control device 4. Therefore, when the input signals 30h are described as if their values change at a certain time, such description does not mean that the values of the input signals 30h change at that timing.

The input signals 30h are understood to specify conditions for switching between performing and stopping control by the mechanism control device 4. That is, although the control by the mechanism control device 4 progresses with time (or rotation of the master shaft) in the horizontal axis direction of FIG. 5, there is a case where it is necessary to wait for a condition for executing a specified operation to be satisfied when the specified operation is performed. For example, after it is confirmed that the carrying-in of the processing object from the upstream device is completed or the operation of the device necessary for the work T, for example, the discharge of a predetermined amount of the adhesive is completed, the next operation is performed.

The input signals 30h in FIG. 5 are described as operation completion signals, and are signals indicating that operations of devices associated with some actual mechanism 2 have been completed or are in operation. At this time, the meaning of the description of the input signals 30h is input signal, the time (or rotation of the master shaft) is advanced and each mechanism element is operated as specified when the value of the external input matches the value specified as the input signal 30h. If the value of the external input does not match the value specified as the input signal 30h, the time (or rotation of the master shaft) is stopped and the process waits until the value of the external input matches the value specified as the input signal 30h. By making it possible to designate such input signals 30h as designation items, the operation command generation device 3 can generate an operation command that can be switched between executing and stopping based on an external input.

Further, the execution and stop of controlling by the mechanism control device 4 may be switchably designated without depending on an external input. The breakpoints 30c are designation items for designating a temporary stop position of control by the mechanism control device 4. In the example of FIG. 5, breakpoints are designated at two locations indicated by numbers 1 and 2, but this is to temporarily stop the control by the mechanism control device 4 when the time (or rotation of the master shaft) advances and reaches the timing designated as a breakpoint. The stopped control can be resumed by an operation of the operation terminal 5 described later.

By appropriately specifying the breakpoint, when the work T is newly constructed or the contents of the work T are partially changed, the operation contents of each mechanism element included in the work T can be finely checked. If it is confirmed that there is no problem in the operation content of each mechanism element designated as the task T, the breakpoint may be deleted or invalidated as described later.

By using the GUI described above, the movement curve designation part 30 allows the user to describe the work T as a movement curve 30i based on the virtual mechanism 7 or an aggregate of other designation items without the need to specifically construct the virtual mechanism 7. Therefore, it is possible to easily describe automatic control based on a virtual unique mechanical mechanism without requiring special knowledge unique to the actual mechanism 2, here, an industrial robot. Further, when the virtual unique mechanical mechanism coincides with the existing unique mechanical mechanism, the assets of automatic control described based on the unique mechanical mechanism can be effectively utilized.

Returning to FIG. 4, the operation command generation part 33 will be described before the virtual mechanism information designation part 31 and the virtual mechanism information holding part 32. As described above, the operation command generation part 33 generates an operation command of the actual mechanism 2 based on the movement curve designated by the user in the movement curve designation part 30. That is, based on the movement curve 30i in FIG. 5 specified for the virtual mechanism 7 in FIG. 3 and other specified items, an operation command for the actual mechanism 2 in FIG. 3 is generated.

The generation method itself does not have to be limited to a specific method. For example, if identity transformation for associating the state of a specific virtual mechanism 7 with the state of a specific actual mechanism 2 is clear, an appropriate operation command will be obtained by obtaining the state of the actual mechanism 2 based on the movement curve 30i shown in FIG. 5 and other specified items and generating an operation command for commanding the state. Such a method is not denied at all.

However, the mapping from the state of the virtual mechanism 7 to the state of the actual mechanism 2 is not necessarily an injection and may not be clear. Therefore, the operation command generation part 33 according to the present embodiment generates an operation command by a method described below.

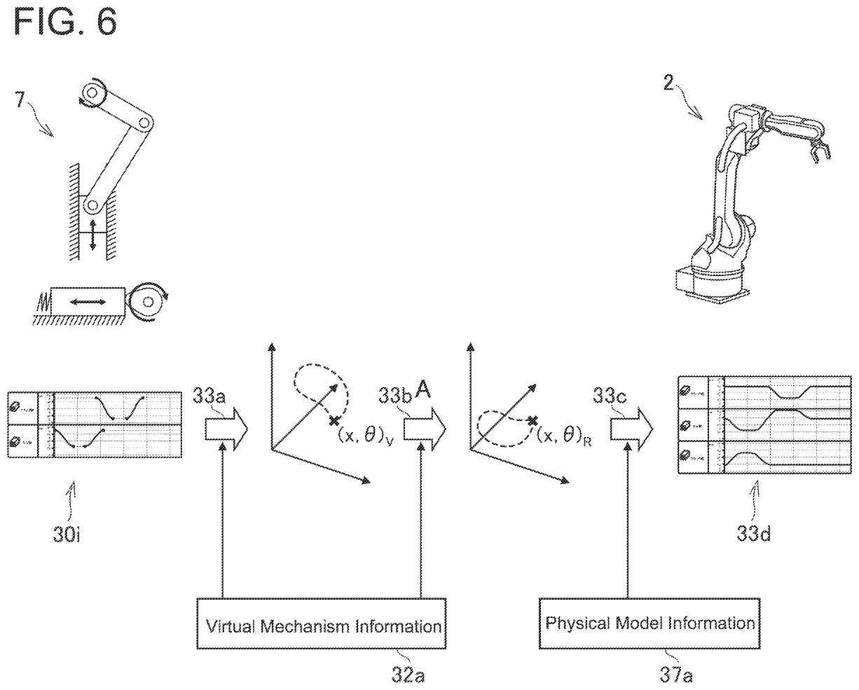

FIG. 6 is a conceptual diagram illustrating a method of generating an operation command by the operation command generation part 33. In this method, each variable in the virtual mechanism 7 is converted into each variable in the actual mechanism 2 via a target point to obtain an operation command

First, as shown at the left end of FIG. 6, for the virtual mechanism 7, a movement curve 30i is specified for each mechanism element included in the virtual mechanism 7. On the other hand, first, a target value (x, θ) v in virtual mechanism coordinates V, which is a coordinate system for the virtual mechanism, is obtained by conversion 33a.

The target value (x, θ) v indicates the position and orientation of the action end of the virtual mechanism 7 at a certain time tin a three dimensional space, and is a six dimensional value. The relationship for obtaining the target value (x, θ) v from the movement curve 30i is included in the virtual mechanism information holding part 32 as a component of the virtual mechanism information 32a. This relationship defines the mechanical relationship between the mechanical elements of the virtual mechanism 7. Such a mechanical relationship is given, for example, as a relational equation for obtaining the target value (x, θ) v from the value of each movement curve 30i at a certain time t.

Since the target value (x, θ) v is obtained over the entire time range, a trajectory of the target value (x, θ) v in the virtual mechanism coordinates V is obtained. The trajectory of the target value (x, θ) v is a closed curve in the virtual mechanism coordinates V.

Subsequently, the target value (x, θ) v in the virtual mechanism coordinates V is converted into the target value (x, θ) r in the real mechanism two coordinates R by the conversion 33b. The real mechanism coordinate R is a coordinate system for the actual mechanism 2, and if the actual mechanism 2 is an industrial robot, the real mechanism coordinate R may be a robot coordinate system. Since the conversion 33b is a simple coordinate conversion, this conversion may be a simple affine conversion, and an affine matrix A may be given. By this conversion 33b, the locus of the target value (x, θ) r in the actual mechanism coordinates R is obtained as a closed curve.

The affine matrix A may also be included in the virtual mechanism information holding part 32 as a component of the virtual mechanism information 32a. The transformation matrix A is information defining the relationship between the virtual mechanism 7 and the actual mechanism 2. By using such information, the action of the action end described for the virtual mechanism 7 can be expressed as an action for the actual mechanism 2.

Here, if the mechanism control device 4 allows the target value (x, θ) r for the time t in the actual mechanism coordinates R to be directly given as an operation command, the obtained target value (x, θ) r can be used to immediately generate an operation command for the actual mechanism 2, and thus it is not necessary to perform inverse kinematics calculation 33c described below in the operation command generation part 33. When a robot controller for controlling many general-purpose industrial robots is used, it is considered that the inverse kinematics calculation 33c is unnecessary.

However, the actual mechanism 2 is not necessarily limited to a general-purpose industrial robot, and even if an industrial robot is used, when a movable element is further provided in an end effector thereof, an operation command cannot be immediately obtained from the target value (x, θ) r.

Then, inverse kinematics calculation 33c is performed. In this calculation, a value 33d of a variable that determines the state of the actual mechanism 2 is obtained by performing an inverse calculation, a so-called inverse kinematics calculation, on the target value (x, θr. At this time, the relationship between the variables of the actual mechanism 2 necessary for performing the inverse kinematics calculation is included in the physical model information 37a held in the physical model information holding part 37. Then, if the value 33d of the variable that determines the state of the actual mechanism 2 with respect to the time t is known, the operation command generation part 33 can easily generate the operation command of the actual mechanism 2.

Since the target value (x, θ) r for the inverse kinematics calculation 33c is obtained from the target value (x, θ) r indicating the operation of the virtual mechanism 7, the operation command generation part 33 generates an operation command using the inverse kinematics calculation 33c based on the operation of the virtual mechanism 7. The target value (x, θ) r indicating the operation of the virtual mechanism 7 is obtained from the movement curve 30i of the plurality of mechanism elements of the virtual mechanism 7 and the mechanical relationship between the mechanism elements.

Therefore, the virtual mechanism information designation part 31 in FIG. 4 designates, as the virtual mechanism information, a mechanical relationship between a plurality of mechanism elements of the virtual mechanism 7 and a relationship between the virtual mechanism 7 and the actual mechanism 2. This designation method is arbitrary and is not particularly limited. These relationships may be input by an appropriate GUI, or a data file describing such relationships may be prepared according to a specific format, and such a file may be imported. The designated virtual mechanism information is held by the virtual mechanism information holding part 32 and used by the operation command generation part 33.

The operation command output part 34 outputs the operation command generated by the operation command generation part 33 to the mechanism control device 4. By executing such an operation command by the mechanism control device 4, even if the actual mechanism 2 and the virtual mechanism 7 have different mechanical configurations, the work T described as that for the virtual mechanism 7 is realized by the actual mechanism 2.

The physical model information held in the physical model information holding part 37 may further include a virtual model of a mechanical component constituting the actual mechanism 2 in addition to the relationship between variables of the actual mechanism 2 used for the inverse kinematics calculation described above. These relationships and virtual models are designated by the user using the physical model information designation part 36 by an arbitrary GUI or other method.

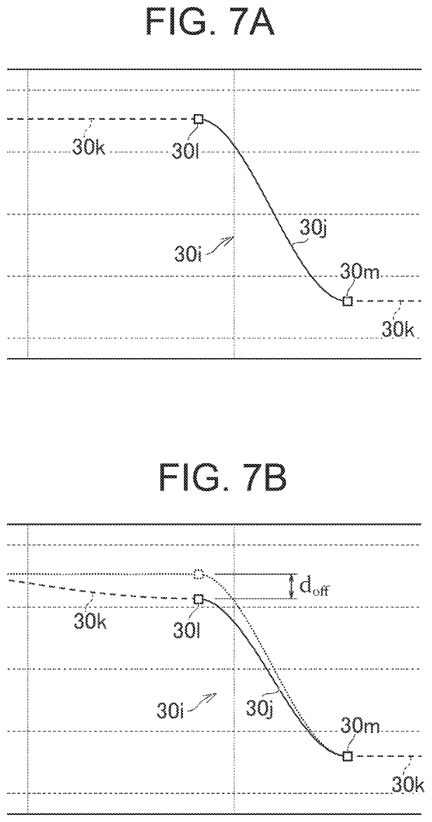

Here, in the operation command generated by the operation command generation part 33, the start point 30l and the end point 30m of the unit movement curve 30j designated by the user can be offset based on an external input. FIGS. 7A and 7B are diagrams for explaining an offset operation.

The movement curve 30i shown in FIG. 7A is an enlarged view of a part of the movement curve 30i shown by the shaft 30d in FIG. 5. At this time, the mechanism elements indicated by the shaft 30d are designated to move from the start point 30l to the end point 30m as indicated by the unit movement curve 30j as shown in the figure.

Although the operation performed by the mechanism elements shown in the shaft 30d may be any operation, when the mechanism elements perform some operation, for example, gripping or processing, on the carried article, the ideal position of the start point 30l may be different from the position of the start point 30l shown in FIG. 7A due to various causes such as positioning accuracy and variation in shape at the time of carrying the article. There is a possibility that the ideal position of the start point 30l is different every time the operation T is repeated.

Therefore, for example, the position and shape of the carried article are acquired by an arbitrary external device, for example, an image processor using a range sensor or an image sensor, and an offset doff, which is a deviation from the start point 30l indicated in the movement curve 30i, is input to the mechanism control device 4 as an external input.

The movement curve designation part 30 can designate the external input as an offset value to the start point 30l. FIG. 7B shows how the movement curve 30i changes when an offset value doff is input as such an external input. In FIG. 7B, a dotted line indicates a movement curve 30i originally designated by the user in the movement curve designation part 30, and a solid line or a broken line indicates an operation performed by the actual mechanism 2 based on an operation command generated by the operation command generation device 3, which is converted into an shaft 30d and displayed.

As shown in FIG. 7B, the start point 30l is offset from the position specified by the user by an externally input offset doff, and can be an ideal position for the task T. On the other hand, since no offset is designated for the end point 30m, there is no change from the position designated by the user, and the offset of the start point 30l does not affect the subsequent operation.

The shape of the unit movement curve 30j connecting the start point 30l and the end point 30m is recalculated so as to be the curve shape designated by the user. Similarly, the shape of the connecting movement curve 30l is recalculated so that the offset start point 30k and the previous position are connected. A curve shape specified in advance is also used for the curve shape of the connection movement curve 30k.

That is, the shapes of the unit movement curve 30j or the connection movement curve 30k before and after the start point 30l for which the offset is designated are recalculated, and the shape of the movement curve 30i is changed so that the mechanism element continuously operates even if the offset is made.

In the above description, the offset is designated only for the start point 30l, but it is naturally possible to designate the offset for the end point 30m in a similar manner. Further, the number of the start point 30l and the end point 30m for specifying the offset is not limited, and the offset may be specified for all the start point 30l and the end point 30m. If necessary, at least one of the start point 30l and the end point 30m may be offset based on an external input.

Returning to FIG. 4, the operation of the load variation calculation section 35 will be described. Although the load variation calculation section 35 calculates the load variation of the electric motor included in the actual mechanism 2 as described above, the movement curve 30i in FIG. 5 specified by the user relates to the mechanism elements of the virtual mechanism 7, and the actual mechanism 2 and the virtual mechanism 7 do not necessarily match each other, therefore it is difficult to directly obtain the load of the electric motor included in the actual mechanism 2 from the movement curve 30i. Further, since the external forces 30e designated by the user are also shown for the “axes” in FIG. 5, i. e., the mechanical elements of the virtual mechanism 7, it is not directly known what kind of load acts on the electric motor included in the actual mechanism 2.

Therefore, the load variation calculation section 35 uses various kinds of information obtained by the operation command generation part 33 to generate an operation command. To be specific, the value 33d of the variable that determines the state of the actual mechanism 2 shown in FIG. 6 is used. This is nothing but an operation of the electric motor included in the actual mechanism 2.

Further, the load variation calculation section 35 refers to the physical model information held in the physical model information holding part 37. The physical model information includes a physical model of the actual mechanism 2, and at least information such as the masses and moments of inertia of mechanisms driven by the electric motors included in the actual mechanism 2 and the reduction ratios of the electric motors. Therefore, a temporal change in torque acting on the electric motors can be calculated from these values and the operation of the electric motors.

When the actual mechanism 2 is a multi joint robot as shown in FIG. 1 and the like, the moment of inertia of the tip portion driven by the electric motor used in the intermediate joint of the robot arm can change depending on the posture of the tip portion (for example, if the tip portion is extended, the moment of inertia is large, and if the tip portion is folded to be small, the moment of inertia is small). The physical model information may include information about the shapes and masses of the movable parts constituting the actual mechanism 2, and the load variation calculation section 35 may obtain the moments of inertia by physical simulation based on the attitude of the actual mechanism 2. Alternatively, the physical model information may include the masses of mechanisms driven by a certain motor and the maximum values of the moments of inertia, and the load variation calculation section 35 may calculate the torque acting on the motor using the maximum values of the moments of inertia.

For further accuracy, the load variation calculation section 35 calculates the influence of the external forces 30e specified by the user. As shown in FIG. 5, the external forces 30g specified by the user are specified for the direction of variation of the mechanism elements of the virtual mechanism 7.

Therefore, the load variation calculation section 35 needs to indicate the external forces in the directions of variables that determine the state of the actual mechanism 2. This method is substantially the same as the method of generating an operation command by the operation command generation part 33 shown in FIG. 6.

That is, the external forces specified by the user are obtained as the direction and magnitude in the virtual mechanism coordinates V by the conversion 33a. Further, the external forces indicated in the virtual mechanism coordinates V are obtained as the direction and magnitude in the real mechanism coordinates R by the conversion 33b. Further, from the values of the variables that determine the state of the actual mechanism 2 obtained by the inverse kinematics calculation 33c, the magnitudes of forces that the external forces at the real mechanism coordinates R at a certain time t exert on the variation directions of the variables that determine the state of the actual mechanism 2 can be calculated. Therefore, based on the magnitudes of the forces, torques due to the external forces acting on the motors included in the actual mechanism 2 can be obtained.

Finally, the load fluctuation of the electric motor included in the actual mechanism 2 can be obtained as the sum of the inertial torque obtained from the movement curve 30i and the physical model information designated by the user and the external torque obtained from the external force 30e designated by the user.

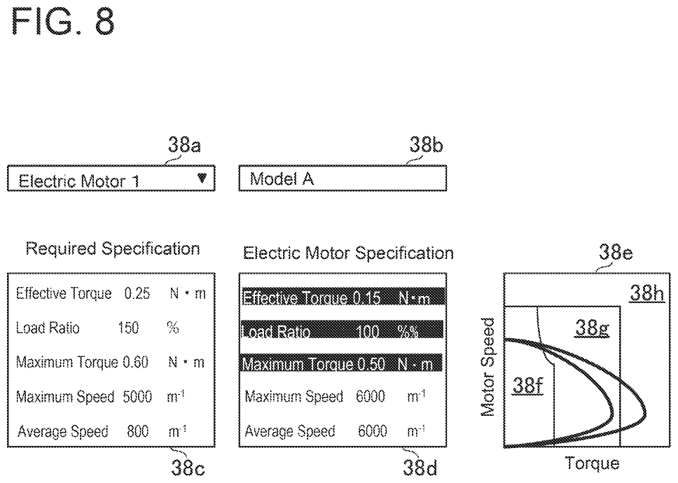

The motor selection information output unit 38 presents the load variation of the motor calculated by the load variation calculation section 35 to the user, and provides information about the motor to be selected. FIG. 8 is a diagram illustrating an example of a GUI presented to the user by the motor selection information output unit 38.

On the GUI, necessary information is presented to the user. The GUI includes a motor designation section 38a for indicating the presentation of the information about which motor among the motors included in the actual mechanism 2 and designating information about which motor the user ask for, a model designation section 38b for designating a model name of the motor selected for the designated motor and specifying a model of the motor by the user, a required specification display section 38c for displaying specifications required for the motor from the load variation of the motor calculated by the load variation calculation section 35, a motor specification display section 38d for displaying specifications of the model of the motor currently selected, and a load variation display section 38e for displaying the load variation of the motor calculated by the load variation calculation section 35 as a locus on a graph. The type of information to be included in the GUI and the display method thereof are arbitrary.

In the motor designation section 38a, a motor is specified by an identification name for identifying a plurality of motors included in the actual mechanism 2. The identification name may be specified by the physical model information. On the other hand, the specifications of the electric motor are not specified from this information. The user can select any of the electric motors included in the actual mechanism 2 by selecting the electric motor designation section 38a on the GUI. When a motor is selected, the display contents of the model designation section 38b, the required specification display section 38c, the motor specification display section 38d, and the load variation display section 38e are switched to those for the selected motor.

In the model designation section 38b, a model of a product selected as the selected electric motor is specified. The user can select a model of an actually available electric motor product by selecting the model designation section 38b on the GUI. The GUI for selecting the model of the electric motor product will be described later. The model designation section 38b specifies a specific model of the electric motor product used as the selected electric motor, thereby specifying specific specifications of the electric motor.

The required specifications display section 38c displays the required specifications of the selected electric motor based on the load fluctuation of the electric motor calculated by the load variation calculation section 35. In the example of FIG. 8, the effective torque, the load ratio, the maximum torque, the maximum speed and the average speed are shown. The required specifications are information indicating that work T cannot be performed unless the selected electric motor has performance satisfying the required specifications.

In the electric motor specification display section 38d, the specifications of the model of the motor product selected for the selected motor are displayed. Regarding the information displayed at this time, the electric motor selection information output part (motor selection information output circuitry) 38 holds the models available to the user as a database in advance. Further, in the electric motor specification display section 38d, the electric motor specifications corresponding to the request specifications displayed in the required specification display portion 38c may be displayed in association with each other so that the user can easily compare the both. In the example of FIG. 8, the requirement specifications and the electric motor specifications in the correspondence relationship are shown adjacent to each other in the lateral direction to indicate that they correspond to each other.

Although the motor specifications must satisfy the required specifications, if the motor specifications do not satisfy the required specifications, the lacking motor specifications are highlighted as shown in FIG. 8 to clearly indicate that the performance of the model of the motor product selected as the motor is lacking. By looking at such a display, the user can immediately understand that the model of the motor product currently selected needs to be changed.

The load fluctuation display section 38e graphically displays a locus of load variation that the selected electric motor receives when the actual mechanism 2 executes the work T. In the example of FIG. 8, a change in the operating state of the electric motor on a plane in which the horizontal axis represents the electric motor torque and the vertical axis represents the electric motor speed is indicated by a thick line. In this plane, a region 38f indicates an operating condition under which the motor can be operated steadily, a region 38g indicates an operating condition under which the motor can be operated non-steadily (short-time operation), and a region 38h indicates an operating condition under which the motor cannot be operated due to overloading. The operating condition under which the selected electric motor executes the work T can be clearly understood by looking at the locus shown in the plane.

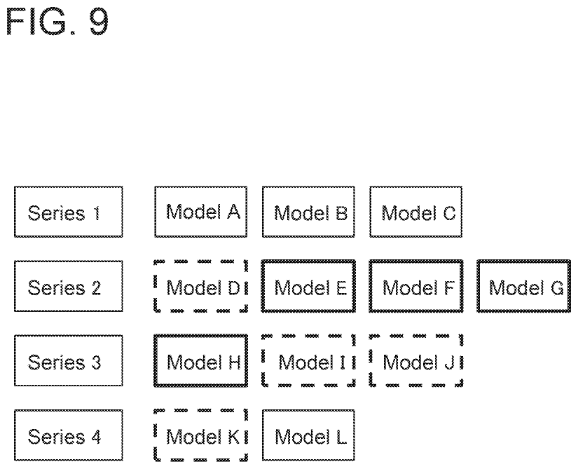

FIG. 9 is a diagram showing an example of a GUI for a user to select a model of an electric motor product, which is displayed by selecting the model designation section 38b on the GUI of FIG. 8. On the GUI, each model of the electric motor product is displayed in an organized manner so that the user can easily grasp each model. In the example of FIG. 9, the electric motor products are classified into series 1 to series 4 and arranged. Such classification may be selected based on specifications, shapes, and the like of electric motor products so as to be easily understood by a user.

In addition, the displayed models are provided with different display modes. In the present embodiment, the display mode is made different by changing the display color, but how to make the display mode different is arbitrary. Further, in FIG. 9, in order to indicate the difference in color, the frames indicating the models are distinguished by being indicated by a thin line, a thick broken line, and a thick line. In this example, a thin line indicates red, a thick broken line indicates yellow, and a thick line indicates green.

The difference in the display mode is selected according to how much the specifications of each model of the electric motor product displayed on the GUI satisfy the required specifications of the electric motor obtained from the load variation of the electric motor calculated by the load variation calculation section 35. That is, when the specifications of the electric motor product related to the displayed model satisfy all the required specifications (that is, when steady operation is possible), the color is green, when the required specifications are partially satisfied (that is, when operation is possible if unsteady operation is permitted), the color is yellow, and when the required specifications are not satisfied (that is, when operation is impossible), the color is red.

As described above, based on the load variation of the electric motor obtained for the task T, the electric motor selection information indicating whether or not the model of the electric motor product satisfies the required specifications, that is, whether or not the electric motor related to a specific model can be selected, is shown on the GUI for selecting the model of the electric motor product. Further, since the load variation display section 38e of FIG. 8 shows changes in the operating state of the electric motor with respect to the operating conditions of the electric motor, it is easy to determine whether the actual mechanism 2 can be constructed at a lower cost by selecting, as the selected electric motor, a model of a high-performance electric motor product that can be operated under operating conditions that allow steady operation at all times or a model of an electric motor product that can be operated under operating conditions that allow unsteady operation.

When the user selects a model of a desired motor product on the GUI of FIG. 9, the model name displayed in the model designation section 38b of FIG. 8 is changed, and accordingly, the motor specifications displayed in the motor specification display section 38d and the shapes of the regions 38f, 38g, and 38h in the load variation display section 38e correspond to the selected model of the motor product.

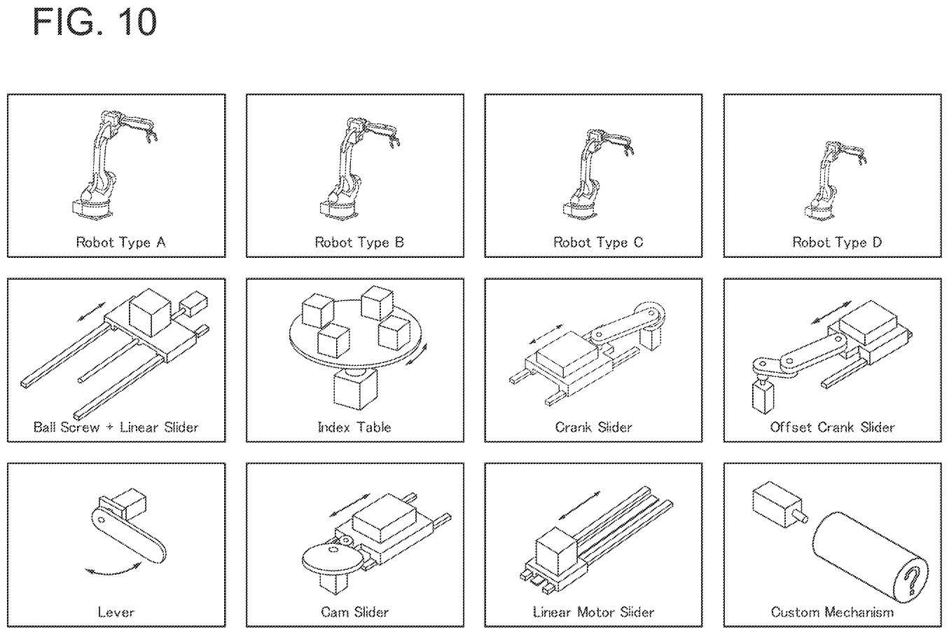

Returning to FIG. 4, an example of the GUI of the physical model information designation part 36 will be described. The physical model information designation part 36 may be of any type as long as the user can designate information necessary as the physical model information described above. In the present embodiment, as an example of such a GUI, FIG. 10 shows an example of a GUI in which a user selects a physical model.

In the GUI, candidates of a plurality of mechanisms having a high possibility of being used by the user as the actual mechanism 2 are shown as a list in advance. For example, if the user wants to use an industrial robot, the user may select a suitable mechanism from among the candidates displayed in the upper row, and if the user wants to use another mechanism, the user may select an appropriate mechanism from among the candidates displayed in the middle and lower rows.

The physical model information designation part 36 prepares physical model information in advance for a mechanism presented to the user as an option. Therefore, the user can easily designate the physical model information simply by selecting the presented mechanism or by requesting additional input such as dimensions and masses of necessary parts after selecting the mechanism.

The user may designate the physical model information by other methods. For example, a file describing the physical model information in accordance with a predetermined format or a three-dimensional model created by commercially available three dimensional CAD software may be imported as the physical model information.

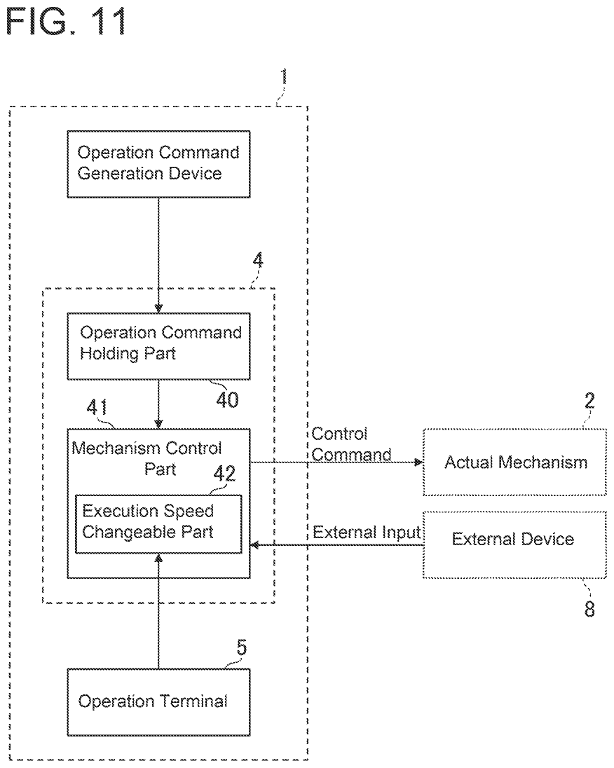

FIG. 11 is an overall structural block diagram of the mechanism control system 1 including the operation command generation device 3 described above. In the mechanism control system 1, an operation command generated by the operation command generation device 3 is sent to the mechanism control device 4 and held in the operation command holding part 40. The mechanism control device 4 controls the actual mechanism 2 to execute the work T by causing the mechanism control part (the mechanism control circuitry) 41 to read and execute the operation command from the operation command holding part 40 and to output the control command to the actual mechanism 2.

At this time, external input is received from various external devices 8 such as upstream and downstream devices and sensors, and execution and stop of control are switched based on an input signal included in the external input, or a control target position of the actual mechanism 2 is offset based on an offset distance included in the external input.

Further, the mechanism control part 41 may include an execution speed changeable part (execution speed changeable circuitry) 42 capable of changing an execution speed and a direction of control of the actual mechanism 2, and a command from the user to the mechanism control part 41 itself or an instruction from the user to the execution speed changeable part 42 may be made by the operation terminal 5.

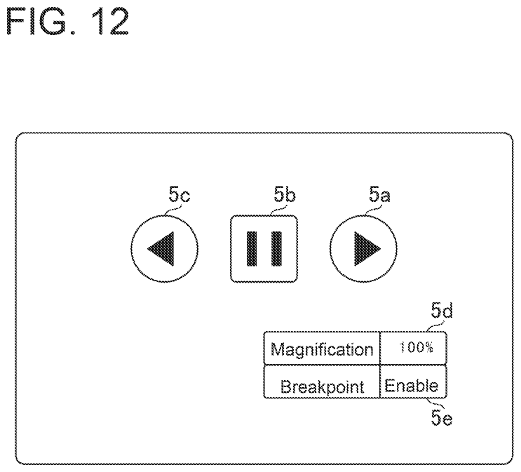

FIG. 12 is a diagram illustrating an example of a GUI in the operation terminal 5. The operation terminal 5 is a device used by a user to instruct start and stop of execution of the work T itself and an additional condition during execution, and a portable computer terminal such as a tablet PC, a touch panel product used for operation of industrial equipment, a dedicated switch board, or the like may be used as appropriate. FIG. 12 shows a case where a tablet PC is used as the operation terminal 5.

In the GUI shown in FIG. 12, an execute button 5a, a stop button 5b, a reverse direction execute button 5c, a speed multiplying factor setting unit 5d, and a breakpoint enable/disable switching unit 5e are prepared.

The execute button 5a is an interface for instructing the actual mechanism 2 to execute the work T by the mechanism control part 41. When the user selects the execute button 5a, the mechanism control part 41 starts the operation of the actual mechanism 2, and the work T is repeatedly executed. The stop button 5b is an interface for instructing to stop the work T. When the user selects the stop button 5b, the mechanism control part 41 immediately stops the operation of the actual mechanism 2 being executed at that time point. The operation is resumed by selecting the execute button 5a again. Further, the operation of the actual mechanism 2 stopped by the arrival of the aforementioned breakpoint is also resumed by selecting the execute button 5a.

The reverse direction execute button 5c is an interface for instructing the actual mechanism 2 to execute the work T in the reverse direction by the mechanism control part 41. That is, the operation of the actual mechanism 2 based on the reverse direction execute button 5c is performed so as to trace back the time (or the rotation angle of the master shaft) shown in FIG. 5 in the reverse direction. That is, each operation of the task T shown in FIG. 5 is executed so as to proceed from right to left in the drawing.

The speed of the operation of the actual mechanism 2 in the forward direction or the reverse direction by the execute button 5a and the reverse direction execute button 5c can be changed by setting the speed magnification using the interface of the magnification designation part 5d. That is, when 100% is designated as the speed magnification, the work T is executed at the speed as designated by the user in FIG. 5, whereas if 50% is designated, the operation is performed slowly at half the speed, and if 200% is designated, the operation is performed at high speed at double the speed.

The direction and speed of the operation of the actual mechanism are changed by an execution speed changeable part 42. An executing speed variable part 42 overwrites a control command outputted from a mechanism control part 41 to an actual mechanism 2 so as to operate at a speed multiplied by a speed magnification designated by a magnification designation part 5d, and sets the direction of operation by the control command and the executing order of operation commands to a forward direction or a reverse direction according to the direction of operation by selection of an execute button 5a and a reverse direction execute button 5c.

Further, the breakpoint enable/disable switching unit 5e enables the user to select whether to enable or disable the stop of the operation of the task T by the breakpoints described with reference to the breakpoints 30c in FIG. 5. That is, when the enable is selected by the breakpoint enable/disable switching unit 5e, the mechanism control device 4 stops the operation of the work T in accordance with the command of the breakpoint included in the operation command. On the other hand, that is, when disable is selected by the breakpoint enable/disable switching unit 5e, the mechanism control device 4 ignores the command of the breakpoint included in the operation command.

Thereby, when operating the actual mechanism 2 first time, the actual mechanism 2 is stopped at the breakpoint as specified in advance and it is possible to confirm the whole operation of the work T by confirming the execution contents. On the other hand, by selecting disable in the breakpoint enable/disable switching unit 5e after confirming the operation, the work T can be continuously executed without removing the designated breakpoint and recreating the operation command and without stopping the operation at the breakpoint.

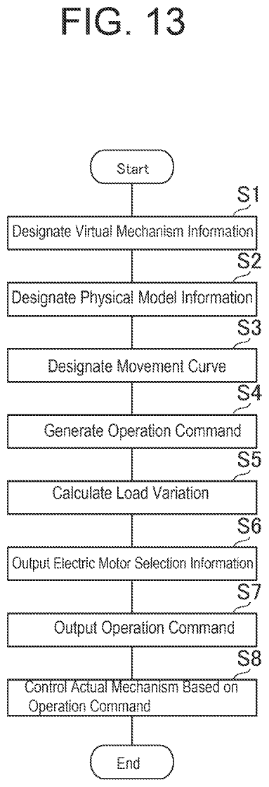

FIG. 13 is a flowchart showing a method of generating an operation command for the actual mechanism 2 and a method of controlling the actual mechanism 2, which are executed by the mechanism control system 1.

First, in step S1, virtual mechanism information is designated in advance. This is realized by the virtual mechanism information designation part 31 already described with reference to FIG. 4. In the following step S2, physical model information is designated. This is also realized by the physical model information designation part 36 described with reference to FIG. 4.

Then, in step S3, a movement curve is specified. This may be performed as described with reference to FIG. 5 using the movement curve designation part 30 shown in FIG. 4. After the maintenance curve is specified, an operation command is generated in step S4 based on the movement curve. This operation command is generated by the operation command generation part of FIG. 4 by the method described with reference to FIG. 6.

Steps S1 to S4 thus far show how to generate an operation command for the task T. Further, control methods of the actual mechanism 2 are shown up to step S8.

In step S5, the load fluctuation of the electric motor included in the actual mechanism 2 is calculated based on the specified physical model information 37a. This calculation is performed by the load variation calculation section 35 described with reference to FIG. 4. Based on the calculated load variation, motor selection information is output in step S6 and presented to the user. The user selects an appropriate electric motor based on the electric motor selection information and constructs the actual mechanism 2.

In step S7, the operation command generated in step S4 is output to the mechanism control device 4. Finally, in step S8, the mechanism control device 4 controls the constructed actual mechanism 2 based on the operation command, so that the work T is realized.

Obviously, numerous modifications and variations of the present invention are possible in light of the above teachings. It is therefore to be understood that within the scope of the appended claims, the invention may be practiced otherwise than as specifically described herein.

What is claimed is:

1. An operation command generation device comprising:
movement curve designation circuitry configured to determine a movement curve describing an operation of each of at least one mechanism element included in a virtual mechanism; and
operation command generation circuitry configured to generate an operation command to control an actual mechanism based on the movement curve.

2. The operation command generation device according to claim 1,
wherein the at least one mechanism element includes a plurality of mechanism elements,
wherein the operation command generation circuitry is configured to generate the operation command according to an inverse kinematics calculation based on an operation of the virtual mechanism obtained from a plurality of movement curves for the plurality of mechanism elements and a mechanical relationship between the plurality of mechanism elements.

3. The operation command generation device according to claim 1, wherein the movement curve includes a start point, an end point, and a unit movement curve connecting the start point and the end point and having a curve shape which has been determined.

4. The operation command generation device according to claim 3, wherein at least one of the start point and the end point is configured to be offset based on an external input.

5. The operation command generation device according to claim 1, wherein the movement curve is a repetition curve that is repeated at every predetermined cycle.

6. The operation command generation device according to claim 1, wherein the operation command is executed or is not executed based on an external input.

7. The operation command generation device according to claim 1, wherein the actual mechanism includes a motor,
the operation command generation device further comprising:
a physical model information storage configured to storage physical model information of the actual mechanism; and
load variation calculation circuitry configured to calculate load variation in a motor load of the motor based on the physical model information.

8. The operation command generation device according to claim 7, further comprising:
motor selection information output circuitry configured to output motor selection information indicating which motor is to be selected based on the load variation.

9. The operation command generation device according to claim 7, wherein the load variation calculation circuitry is configured to calculate the load variation based on the information indicating an external force.

10. A mechanism control system comprising:
the operation command generation device according to claim 1; and
mechanism control circuitry configured to control the actual mechanism according to the operation command.

11. The mechanism control system according to claim 10, further comprising:
execution speed changeable circuitry configured to change an execution speed and a direction of control of the actual mechanism.

12. A non-transitory computer readable storage medium retrievably storing a computer-executable program therein, the computer-executable program causing a computer to perform an operation command generation method, the method comprising:
determining a movement curve describing an operation of each of at least one mechanism element included in a virtual mechanism; and
generating an operation command to control an actual mechanism based on the movement curve.

13. An operation command generation method comprising:
determining a movement curve describing an operation of each of at least one mechanism element included in a virtual mechanism; and
generating an operation command to control an actual mechanism based on the movement curve.

14. A mechanism control method comprising:
determining a movement curve describing an operation of each of at least one mechanism element included in a virtual mechanism;
generating an operation command to control an actual mechanism based on the movement curve; and
outputting the operation command to the actual mechanism.
